(19) United States
(12) Patent Application Publication
(10) Pub. No.: US 2006/0234783 A1
(43) Pub. Date: Oct. 19, 2006

(54) WIRELESS RECEIVER WITH A FOLDABLE ANTENNA

(76) Inventors: Hung-Chih Wang, Kao-Hsiung City (TW); Chen-Hsing Wang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/161,310

(22) Filed: Jul. 29, 2005

(30) Foreign Application Priority Data
Apr. 18, 2005 (TW) 094206041

(51) Int. Cl. H04M 1/00

(52) U.S. Cl. 455/575.1

(57) ABSTRACT

A wireless receiver has a first housing, an antenna installed inside the first housing for receiving digital video/audio signals, a second housing, a flexible pipe connected to the first housing and the second housing and capable of being bent so as to form an angle between the first housing and the second housing, a tuner installed inside the second housing and electrically connected to the antenna via the flexible pipe for transferring a frequency of the digital video/audio signals received by the antenna, a demodulator installed inside the second housing and electrically connected to the tuner for demodulating the signals transmitted from the tuner, a transmitting interface for transmitting the signals demodulated by the demodulator to a corresponding rendering device, and a controller installed inside the second housing for controlling the transmitting interface to transmit the signals demodulated by the demodulator to the rendering device.

### BACKGROUND OF THE INVENTION

1. Field of the Invention

The present invention relates to a wireless receiver, and more particularly, to a wireless receiver having a foldable antenna.

2. Description of the Prior Art

With the coming of the digital age, traditional analog systems of TV and audio stations are gradually replaced by digital systems. Because of the sensitivity of the signals in analog systems, analog signals are not suitable for transmission in a hostile environment. On the contrary, digital video broadcasting (DVB) systems and digital audio broadcasting systems enable robust communications in extremely hostile environments to provide stable and superior quality TV/radio programs. Additionally, frequency bands are used more efficiently in digital systems rather than in the analog systems. That is, in comparison with analog systems, digital systems are capable of transmitting more programs within the same frequency band. Moreover, many additional services of data broadcasting can be provided in DVB systems.

The sizes of the conventional receivers of DVB systems or digital audio broadcasting systems are usually too large to be conveniently placed in a limited space. For example, Kwang-yong Lee teaches a TV signal receiving module in U.S. publication 2004/0252246. Lee's TV signal receiving module has a USB interface connected to a personal computer to provide signals of TV programs to the personal computer. However, the housing of Lee's TV signal receiving module is too large and inconvenient to carry. The antenna of Lee's TV signal receiving module usually has to be separated from the housing to efficiently receive RF signals, more space is needed for accommodating and using the TV signal receiving module. Additionally, Cheng et al. teach a wireless communication device in U.S. Pat. No. 6,816,121. Cheng's wireless communication device has an antenna for receiving signals. However, because the antenna is connected to the housing via a hinge, the antenna cannot be arbitrarily adjusted to efficiently receive RF signals.

### SUMMARY OF THE INVENTION

It is therefore an objective of the claimed invention to provide a wireless receiver with a foldable antenna to solve the above-mentioned problems.

The wireless receiver has a first housing, an antenna installed in the first housing for receiving digital video signals from a transmitter, a second housing, a flexible pipe connected with the first housing and the second housing and capable of being bent to place the first housing at a predetermined angle from the second housing, a tuner installed in the second housing and connected to the antenna via the flexible pipe for converting a frequency of the digital video signals received from the antenna, a demodulator installed in the second housing and coupled to the tuner for demodulating signals received from the tuner, a transmitting interface for transmitting the demodulated signals to a rendering device, and a controller installed in the second housing for controlling the transmitting interface to transmit the demodulated signals to the rendering device.

It is an advantage of the claimed invention that the angle between the first housing and the second housing can be adjusted to a user-desired angle for efficiently receiving signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view of a wireless receiver with an antenna closed according to the present invention.

FIG. 2 is a diagram of the wireless receiver shown in FIG. 1 with the antenna opened.

FIG. 3 is a block diagram of the first embodiment wireless receiver according to the present invention.

FIG. 4 is a block diagram of the second embodiment wireless receiver according to the present invention.

### DETAILED DESCRIPTION

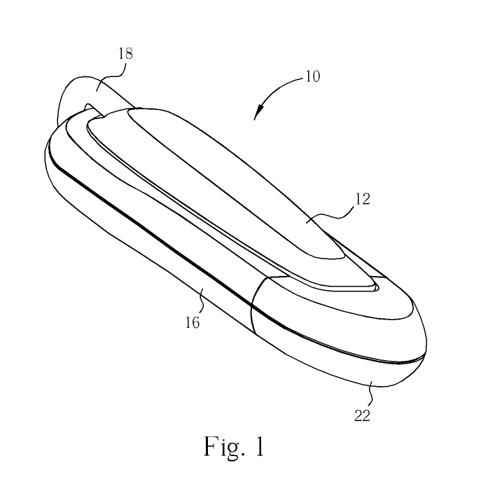

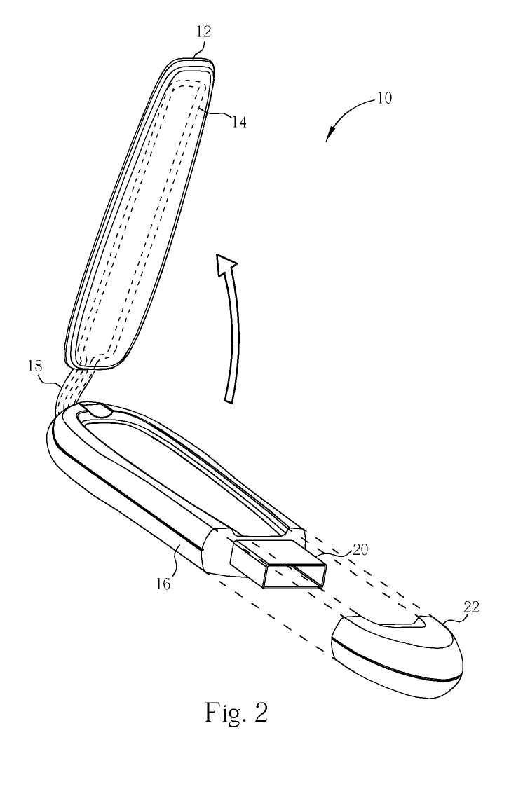

Please refer to FIGS. 1-2. FIG. 1 is a perspective view of a wireless receiver 10 with an antenna 12 closed according to the present invention, and FIG. 2 is another diagram of the wireless receiver 10 with the antenna 12 opened. The wireless receiver 10 can be a digital video broadcasting (DVB) receiver or a digital audio broadcasting receiver. The wireless receiver 10 uses a universal serial bus (USB) interface to connect to a rendering device, such as a notebook, a desktop computer, or a PDA (personal digital assistant).

The wireless receiver 10 comprises a first housing 12 and an antenna 14 installed in the first housing 12 for receiving digital video/audio signals from a transmitter. The antenna 14 has a loop shape. If the wireless receiver 10 is a DVB receiver, the antenna 14 receives digital video signals, such as digital video broadcasting-terrestrial (DVB-T) signals, digital video broadcasting-handheld (DVB-H) signals, or advanced television system committee (ATSC) signals. If the wireless receiver 10 is a digital audio broadcasting receiver, the antenna 14 receives digital audio signals.

The wireless receiver 10 further comprises a second housing 16 for containing components of the wireless receiver 10 and a flexible pipe 18 connected with the first housing 12 and the second housing 16. The flexible pipe 18 can be a plastic tube and can be bent to place the first housing at a predetermined angle from the second housing. Therefore, the flexible pipe 18 allows the antenna 14 to be placed at user-desired direction and angle. The wireless receiver 10 further has a USB plug 20 and a cover 22. The USB plug 20 is used to connect with a corresponding rendering device and to transmit signals to the rendering device. The cover 22 is removable from the USB plug 20 and used to protect the USB plug 20 while the USB plug 20 is disconnected from the rendering device.

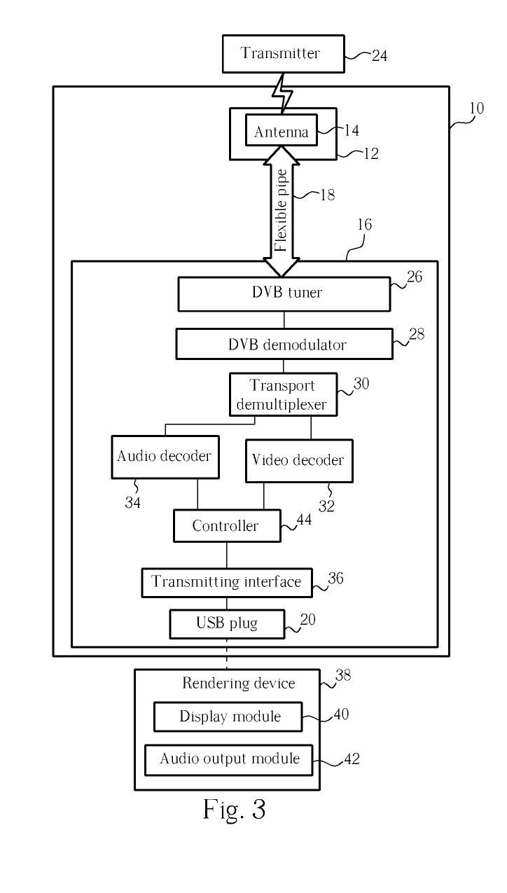

Please refer to FIG. 3, which is a block diagram of the first embodiment wireless receiver 10 according to the present invention. The wireless receiver 10 is a DVB receiver. The antenna 14 of the wireless receiver 10 receives DVB signals from a transmitter 24, i.e. a DVB station. The wireless receiver 10 further comprises a DVB tuner 26 installed in the second housing 16 and coupled to the antenna 14 via the flexible pipe 18 for down converting the frequency of the digital video signals received from the antenna 14. In the embodiment, the DVB tuner 26 is a radio frequency tuning chip. A DVB demodulator 28 of the wireless receiver 10 is installed in the second housing 16 and is coupled to the DVB tuner 26 for demodulating signals received from the tuner 26. A transport demultiplexer 30 of the wireless receiver 10 is installed in the second housing 16 for dividing the demodulated signals into video signals and audio signals. A video decoder 32 of the wireless receiver 10 is installed in the second housing 16 for decoding video signals received from the transport demultiplexer 30. An audio decoder 34 is installed in the second housing 16 for decoding audio signals received from the transport demultiplexer 30. A transmitting interface 36, i.e. a USB interface, transmits the decoded signals received from the video decoder 32 and the audio decoder 34 to a rendering device 38. The rendering device 38 is a notebook or a desktop computer. The rendering device 38 has a display module 40 for displaying images of the decoded signals received from the video decoder 32 and an audio output module 42 for outputting sound of the decoded audio signals received from the audio decoder 34. A controller 44 of the wireless receiver 10, i.e. a USB controller, is installed in the second housing 16 for controlling the transmitting interface 36 to transmit the demodulated signals received from the DVB demodulator 28 to the rendering device 38.

Please refer to FIGS. 2-3. When a user wants to use the wireless receiver 10, he/she separates the first housing 12 from the second housing 16 and uses the flexible pipe 18 to adjust the angle and the direction of the antenna 14. Then the user uses software of the rendering device 38 to send a command to the controller 44 via the transmitting interface 36. After receiving the command from the rendering device 38, the controller 44 transmits control signals to the DVB tuner 26, the DVB demodulator 28, the transport demultiplexer 30, the video decoder 32, and the audio decoder 34. Then, when the user uses the rendering device 38 to select a TV channel, the controller 44 sends a control signal to the DVB tuner 26 to adjust the frequency of the received signal from the antenna 14. The DVB demodulator 28 demodulates the digital signals received from the DVB tuner 26 and sends the demodulated digital signals to the transport demultiplexer 30. The transport demultiplexer 30 divides the demodulated signals into video signals and audio signals. The video signals can be MPGE2 signals, and the audio signals can be MPEG2 signals or DolbyAC-3 signals. The video decoder 32 decompresses the video signals and outputs image data after coordinate correction, conversion, and digital-to-analog conversion. The audio decoder 34 decompresses the Dolby signals and the other surrounding audio signals and outputs analog audio signal after D/A conversion. The controller 44 controls the transmitting interface 36 to transmit the decoded signals received from the video decoder 32 and the audio decoder 34 to the rendering device 38 via the USB plug 20. The display module 40 of the rendering device 38 displays images and the audio output module 42 outputs sound respectively according to the received video signals and audio signals from the transmitting interface 36. In addition, the transport demultiplexer 30, the video decoder 32, and the audio decoder 34 can be built into the rendering device 38 to reduce the cost and size of the wireless receiver 10.

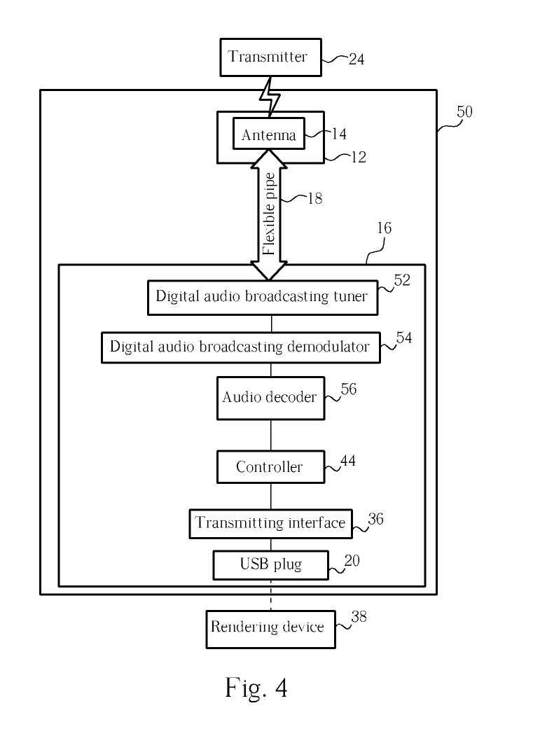

Please refer to FIG. 4, which is a block diagram of the second embodiment wireless receiver 50 according to the present invention. The components indicated by the same numbers in the wireless receivers 10 and 50 have the same structures and functions. The wireless receiver 50 is a digital audio broadcasting receiver. The antenna 14 of the wireless receiver 50 receives digital audio broadcasting signals from a transmitter 24, i.e. a digital audio broadcasting station. The wireless receiver 50 further comprises a digital audio broadcasting tuner 52 installed in the second housing 16 and coupled to the antenna 14 via the flexible pipe 18 for down converting the frequency of the digital audio broadcasting signals received from the antenna 14. In the embodiment, the digital audio broadcasting tuner 52 is a radio frequency tuning chip. A digital audio broadcasting demodulator 54 of the wireless receiver 50 is installed in the second housing 16 and coupled to the digital audio broadcasting tuner 52 for demodulating signals received from the digital audio broadcasting tuner 52. An audio decoder 56 is installed in the second housing 16 for decoding the audio signals received from the digital audio broadcasting demodulator 54. A transmitting interface 36, i.e. a USB interface, transmits the decoded audio signals received from the audio decoder 56 to the rendering device 38. The rendering device 38 is a notebook computer, a desktop computer, a PDA, a speaker, or an earphone. A controller 44 of the wireless receiver 50, i.e. a USB controller, is installed in the second housing 16 for controlling the transmitting interface 36 to transmit the demodulated signals received from the digital audio broadcasting demodulator 54 to the rendering device 38.

Please refer to FIG. 2 and FIG. 3. When a user wants to use the wireless receiver 50 to listen a digital audio broadcasting program, he/she separates the first housing 12 from the second housing 16 and uses the flexible pipe 18 to adjust the angle and the direction of the antenna 14. Then the user uses software of the rendering device 38 to send a command to the controller 44 via the transmitting interface 36. After receiving the command from the rendering device 38, the controller 44 transmits control signals to the digital audio broadcasting tuner 52, the digital audio broadcasting demodulator 54, and the audio decoder 56. Then, when the user uses the rendering device 38 to select a radio channel, the controller 44 sends a control signal to the digital audio broadcasting tuner 52 to adjust the frequency of the received signal from the antenna 14. The digital audio broadcasting demodulator 54 demodulates the digital signals received from the digital audio broadcasting tuner 52 and sends the demodulated digital signals to the audio decoder 56. The audio decoder 56 decodes the digital audio signals and outputs analog audio signal after D/A conversion. The controller 44 controls the transmitting interface 36 to transmit the decoded signals received from the audio decoder 56 to the rendering device 38 via the USB plug 20. The rendering device 38 outputs sound according to the received audio signals from the transmitting interface 36. In addition, the audio decoder 56 can be built into the rendering device 38 to reduce the cost and size of the wireless receiver 50.

In comparison with the prior art, the wireless receiver according to the present invention uses a flexible pipe to connect the antenna and the housing so that the antenna can be adjusted to any user-desired angle and direction for efficiently receiving RF signals. The transmitting interface, which is a USB interface for example, makes it possible to plug in and use the wireless receiver to play digital TV/radio programs. Additionally, the flexible pipe can be folded to place the antenna onto the housing so that the wireless receiver is convenient to carry.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless receiver comprising:
a first housing;
an antenna installed in the first housing for receiving digital video signals from a transmitter;
a second housing;
a flexible pipe connected with the first housing and the second housing and capable of being bent to place the first housing at a predetermined angle from the second housing;
a tuner installed in the second housing and connected to the antenna via the flexible pipe for converting a frequency of the digital video signals received from the antenna;
a demodulator installed in the second housing and coupled to the tuner for demodulating signals received from the tuner;
a transmitting interface for transmitting the demodulated signals to a rendering device; and
a controller installed in the second housing for controlling the transmitting interface to transmit the demodulated signals to the rendering device.

2. The wireless receiver of claim 1 wherein the antenna has a loop shape.

3. The wireless receiver of claim 1 wherein the flexible pipe is a plastic tube.

4. The wireless receiver of claim 1 wherein the digital video signals are digital video broadcasting (DVB) signals, the tuner is a DVB tuner, and the demodulator is a DVB demodulator.

5. The wireless receiver of claim 4 wherein the DVB signals are digital video broadcasting-terrestrial (DVB-T) signals.

6. The wireless receiver of claim 4 wherein the DVB signals are digital video broadcasting-handheld (DVB-H) signals.

7. The wireless receiver of claim 4 wherein the DVB signals are advanced television system committee (ATSC) signals.

8. The wireless receiver of claim 4 wherein the DVB tuner is a radio frequency tuning chip.

9. The wireless receiver of claim 4 further comprising:
a transport demultiplexer installed in the second housing for dividing the demodulated signals into video signals and audio signals;
a video decoder installed in the second housing for decoding video signals received from the transport demultiplexer and transmitting the decoded video signals to the controller; and
an audio decoder installed in the second housing for decoding audio signals received from the transport demultiplexer and transmitting the decoded audio signals to the controller.

10. The wireless receiver of claim 1 wherein the transmitting interface is a universal serial bus (USB) interface and the controller is a USB controller.

11. The wireless receiver of claim 1 wherein the rendering device is a notebook computer.

12. The wireless receiver of claim 1 wherein the rendering device is a desktop computer.

13. A wireless receiver comprising:
a first housing;
an antenna installed in the first housing for receiving digital broadcasting signals from a transmitter;
a second housing;
a flexible pipe connected with the first housing and the second housing and capable of being bent to place the first housing at a predetermined angle from the second housing;
a tuner installed in the second housing and connected to the antenna via the flexible pipe for converting a frequency of the digital broadcasting signals received from the antenna;
a demodulator installed in the second housing and coupled to the tuner for demodulating signals received from the tuner;
a transmitting interface for transmitting the demodulated signals to a rendering device; and
a controller installed in the second housing for controlling the transmitting interface to transmit the demodulated signals to the rendering device.

14. The wireless receiver of claim 13 wherein the antenna has a loop shape.

15. The wireless receiver of claim 13 wherein the flexible pipe is a plastic tube.

16. The wireless receiver of claim 13 wherein the digital broadcasting signals are digital audio broadcasting signals, the tuner is a digital audio broadcasting tuner, and the demodulator is a digital audio broadcasting demodulator.

17. The wireless receiver of claim 16 wherein the digital audio broadcasting tuner is a radio frequency tuning chip.

18. The wireless receiver of claim 13 wherein the transmitting interface is a universal serial bus (USB) interface and the controller is a USB controller.

19. The wireless receiver of claim 13 wherein the rendering device is a notebook computer.

20. The wireless receiver of claim 13 wherein the rendering device is a desktop computer.
